(19) United States
(12) Patent Application Publication
(10) Pub. No.: US 2025/0192848 A1
(43) Pub. Date: Jun. 12, 2025

(54) METHOD AND DEVICE USED FOR WIRELESS COMMUNICATION

(71) Applicants: Xiaobo ZHANG, Shanghai (CN); Qi JIANG, Shanghai (CN)

(72) Inventors: Xiaobo ZHANG, Shanghai (CN); Qi JIANG, Shanghai (CN)

(73) Assignee: SHANGHAI LANGYAO COMMUNICATION TECHNOLOGY COMPANY LIMITED, Shanghai, OT (CN)

(21) Appl. No.: 18/970,980

(22) Filed: Dec. 6, 2024

(30) Foreign Application Priority Data
Dec. 7, 2023 (CN) 202311677818.2

(51) Int. Cl. H04B 7/06; H04L 5/00

(52) U.S. Cl. CPC H04B 7/0626; H04L 5/0005

(57) ABSTRACT

The present application discloses a method and a device for wireless communications. A first node receives a first signaling, the first signaling configuring a first RS resource and multiple time-frequency resources; and performs a first channel measurement for the first RS resource, and performs a first interference measurement for at least one time-frequency resource among the multiple time-frequency resources; and transmits a first CSI; where calculation of the first CSI is dependent on the first channel measurement and the first interference measurement; the at least one time-frequency resource is determined by the first node itself. This application can guarantee the performance of channel information and introduce better scheduling flexibility.

### CROSS REFERENCE TO RELATED APPLICATIONS

This application claims the priority benefit of Chinese Patent Application No. 202311677818.2, filed on Dec. 7, 2023, the full disclosure of which is incorporated herein by reference.

### BACKGROUND

### Technical Field

The present application relates to methods and devices in wireless communication systems, and in particular to a scheme and device for Channel Status Information (CSI) in a wireless communication system.

### Related Art

In traditional wireless communications, the UE (i.e., User Equipment) report may include at least one of a variety of auxiliary information, such as CSI (i.e., Channel Status Information), Beam Management-related auxiliary information, localization-related auxiliary information and so on. The CSI includes CSI-RS Resource Indicator (CRI), Rank Indicator (RI), Precoding Matrix Indicator (PMI), or Channel quality indicator (CQI), etc. The network equipment configures the UE with resources needed to calculate the CSI, which may include Channel Measurement Resource (CMR) and Interference Measurement Resource (IMR), etc., depending on the type of CSI.

In general, the network equipment of a cellular system deterministically configures or indicates the CMR and IMR, and the UE only needs to measure and calculate the CSI on the CMR or IMR indicated by the network equipment. In New Radio (NR) systems, the CMRs for channel measurements includes SS/PBCH block (SSB) and Non-Zero Power (NZP) CSI-Reference Signal (CSI-RS) resources, and the IMRs for interference measurements include NZP CSI-RS resources, Channel State Information-Interference Measurement (CSI-IM) resources, and so on.

The network device selects appropriate transmission parameters for the UE based on the UE's report, such as the cell being camped, Modulation and Coding Scheme (MCS), Transmitted Precoding Matrix Indicator (TPMI), Transmission Configuration Indication (TCI) and other parameters. In addition, UE reporting can be used to optimize network parameters such as better cell coverage, switching base station based on UE location, etc.

In the New Radio (NR) system, the priority of the CSI reports is defined, and the priority is used to determine whether to assign CSI Processing Unit (CPU) resources for updating corresponding CSI reports, or whether to drop the corresponding CSI reports.

Traditional radars utilize specific sensing waveforms such as Continuous Wave (CW), Frequency Modulated Continuous Wave (FMCW), and Digital coding modulation to realize sensing functions. With the gradual overlap of the frequencies deployed in communication systems and the operating frequencies of radars, Integrated Sensing And Communications (ISAC) has become a hot research direction.

### SUMMARY

In the traditional scheme, the UE determines the relevant resources for channel measurement and interference measurement in full accordance with the indications of the base station: the applicant has found by researches that the existing configuration method of CSI reporting may not be applicable to the next-generation mobile communication system. For example, with the introduction of Integrated Sensing And Communications (ISAC) or artificial intelligence (AI), the UE may need to be more involved in resource management.

To address the above problem, the present application provides a solution. It should be noted that while a large number of embodiments of the present application are directed to ISAC, the present application is also applicable to the field of non-sensing-based communications; especially considering that specific CSI generation algorithms are likely to be non-standardized or self-implemented by hardware equipment vendors. Further, the use of a unified UE (i.e., User Equipment, user) reporting scheme can reduce implementation complexity or improve performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The interpretation of terminology in the present application can refer to the descriptions in TS38 series of the 3rd Generation Partner Project (3GPP) protocols, if necessary:

The present application provides a method in a first node for wireless communications, comprising:
receiving a first signaling, the first signaling configuring a first RS resource and multiple time-frequency resources; and performing a first channel measurement for the first RS resource, and performing a first interference measurement for at least one time-frequency resource among the multiple time-frequency resources; and
transmitting a first CSI;
herein, calculation of the first CSI is dependent on the first channel measurement and the first interference measurement: the at least one time-frequency resource is determined by the first node itself.

In one embodiment, the above method allows the first node to determine the IMR on its own for the indicated CMR to enable more flexible CSI calculation.

In one embodiment, the above method saves air interface overhead compared to reporting CSI individually for each of the multiple time-frequency resources.

In one embodiment, the at least one time-frequency resource being selected out is unknown to the transmitter of the first signaling.

In one embodiment, the at least one time-frequency resource comprises only one time-frequency resource.

In one embodiment, the at least one time-frequency resource is L time-frequency resource(s), the L being configurable.

In one embodiment, the first signaling configures the L.

Specifically, according to one aspect of the present application, characterized in that an interference corresponding to each time-frequency resource among the multiple time-frequency resources and other than the at least one time-frequency resource does not exceed an interference corresponding to any time-frequency resource of the at least one time-frequency resource.

The above method ensures transmission reliability while increasing the scheduling flexibility of the transmitter (i.e. second node) over the multiple time-frequency resources described.

Specifically, according to one aspect of the present application, the above method is characterized in that the first signaling configures a second RS resource to be used for an interference measurement, the second RS resource being different from any one of the multiple time-frequency resources, the first interference measurement including a measurement of the second RS resource.

The above method allows the scheduler to perform more complex scheduling, for example by simultaneously superimposing interference signals of different types or for different purposes on signals sent to the first node, to improve the efficiency of spectrum utilization.

Typically, the second RS resource being used for the first interference measurement is known to the transmitter of the first signaling.

Specifically, according to one aspect of the present application, characterized in that the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

Specifically, according to one aspect of the present application, characterized in that the at least one time-frequency resource means L time-frequency resource(s), and the first CSI includes a first Signal to Noise and Interference Ratio (SINR); assuming that any L time-frequency resource(s) among the multiple time-frequency resources is(are) applied in an interference measurement, an obtained SINR is not lower than the first SINR.

Specifically, according to one aspect of the present application, the above method is characterized in that the at least one time-frequency resource means L time-frequency resource(s), and the first CSI includes a first interference power value:assuming that any L time-frequency resource(s) among the multiple time-frequency resources is(are) applied in an interference measurement, an obtained interference power value is not greater than the first interference power value.

Typically, the stated interference power values are linear values (in milliwatts), or dB values (in millidecibels).

Specifically, according to one aspect of the present application, the above method is characterized in that each time-frequency resource of the at least one time-frequency resource occupies Q subcarrier(s) in one multicarrier symbol: location(s) of the Q subcarrier(s) is(are) dependent on a first sensing waveform.

The above embodiments facilitate a balance between both needs for communication and sensing, hence the integration of communication and sensing.

In one embodiment, a multicarrier symbol is an Orthogonal Frequency Division Multiplexing (OFDM) Symbol.

In one embodiment, a multicarrier symbol is a Discrete Fourier Transform Spread OFDM (DFT-S-OFDM) symbol.

In one embodiment, a multicarrier symbol is a Filter Bank Multi Carrier (FBMC) symbol.

In one embodiment, a multicarrier symbol comprises a Cyclic Prefix (CP).

In one embodiment, the first signaling indicates the Q.

In one embodiment, a pattern made up by the Q subcarriers is predefined.

In one embodiment, the Q subcarriers are defined by means of a table, the table being obtained depending on the frequency-domain characteristics of the first sensing waveform.

In one embodiment, the Q subcarriers are defined by means of a formula, the formula being obtained depending on the frequency-domain characteristics of the first sensing waveform.

In one embodiment, the Q subcarriers are the Q most energetic subcarriers in one multicarrier symbol corresponding to the first sensing waveform.

In one embodiment, the Q subcarriers are composed of Q1 Resource Blocks (RBs) in the one multicarrier symbol, and the Q1 RBs are the Q1 most energetic RBs in the one multicarrier symbol corresponding to the first sensing waveform.

Specifically, according to one aspect of the present application, characterized in comprising:
receiving a second signaling, the second signaling indicating a frequency of the first sensing waveform;
herein, the first sensing waveform is a frequency modulated wave, and the location(s) of the Q subcarrier(s) is(are) dependent on the frequency of the first sensing waveform.

In one embodiment, the second signaling is broadcast, or is multicast.

Compared to unicast signaling, the above signaling makes full use of network-side sensing and can save air interface overhead.

In one embodiment, the second signaling indicates the Q.

The present application provides a method in a second node for wireless communications, comprising:
transmitting a first signaling, the first signaling configuring a first RS resource and multiple time-frequency resources; and
receiving a first CSI;
herein, calculation of the first CSI is dependent on a first channel measurement and a first interference measurement; the at least one time-frequency resource is unknown to the second node; the first channel measurement is performed based on the first RS resource, and the first interference measurement is performed based on at least one time-frequency resource among the multiple time-frequency resources.

Specifically, according to one aspect of the present application, characterized in comprising:
transmitting a second signaling, the second signaling indicating a frequency of the first sensing waveform;
herein, the first sensing waveform is a frequency modulated wave, and the location(s) of the Q subcarrier(s) is(are) dependent on the frequency of the first sensing waveform.

The present application provides a first node for wireless communications, comprising:
a first receiver, receiving a first signaling, the first signaling configuring a first RS resource and multiple time-frequency resources; and performing a first channel measurement for the first RS resource, and performing a first interference measurement for at least one time-frequency resource among the multiple time-frequency resources; and
a first transmitter, transmitting a first CSI;
herein, calculation of the first CSI is dependent on the first channel measurement and the first interference measurement: the at least one time-frequency resource is determined by the first node itself.

The present application provides a second node for wireless communications, comprising:
a second transmitter, transmitting a first signaling, the first signaling configuring a first RS resource and multiple time-frequency resources; and
a second receiver, receiving a first CSI;
herein, calculation of the first CSI is dependent on a first channel measurement and a first interference measurement: the at least one time-frequency resource is unknown to the second node; the first channel measurement is performed based on the first RS resource, and the first interference measurement is performed based on at least one time-frequency resource among the multiple time-frequency resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of communication of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication node according to one embodiment of the present application.

FIG. 5 illustrates a flowchart of transmission between a first node and a second node according to one embodiment of the present application.

FIG. 6 illustrates a schematic diagram of a first interference and a second interference according to one embodiment of the present application.

FIG. 7 illustrates a schematic diagram of a sorting order of frequency-domain units according to one embodiment of the present application.

FIG. 8 illustrates a schematic diagram of signal transmission in Integrated Sensing and Communication (ISAC) according to one embodiment of the present application.

FIG. 9 illustrates a schematic diagram of interference symbols according to one embodiment of the present application.

FIG. 10 illustrates a structure block diagram of a processing device used in a first node according to one embodiment of the present application.

FIG. 11 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of communication of a first node according to one embodiment of the present application, as shown in FIG. 1.

The first node 100 receives a first signaling in step S101, the first signaling configuring a first RS resource and multiple time-frequency resources; and in step S102 performs a first channel measurement for the first RS resource, and performs a first interference measurement for at least one time-frequency resource among the multiple time-frequency resources; and transmits a first CSI in step S103.

In Embodiment 1, calculation of the first CSI is dependent on the first channel measurement and the first interference measurement; the at least one time-frequency resource is determined by the first node itself.

In one embodiment, the first signaling is a Radio Resource Control (RRC) signaling, e.g. the first signaling belongs to an RRC Information Element (IE).

In one embodiment, a name of the RRC IE includes CSI-ReportConfig.

In one embodiment, the RRC IE is a CSI-ReportConfig IE.

In one embodiment, the first RS resource is an SSB, or, is indicated by an SSB-index.

In one embodiment, the first RS resource is a CSI-RS resource, or, is configured by an NZP-CSI-RS-Resource.

In addition to the RS resource, the first RS resource may also be a Cell Reference Signal (CRS) and the like.

In one embodiment, the first signaling comprises at least one Medium Access Control (MAC) Control Element (CE).

In one embodiment, the first signaling comprises one piece of Downlink Control Information (DCI).

In one embodiment, any one of the multiple time-frequency resources may be configured for transmitting a reference signal, or configured for transmitting a sensing signal.

In one embodiment, any one of the multiple time-frequency resources is periodic.

In one embodiment, any one of the multiple time-frequency resources occupies multiple Resource Elements (REs).

Typically, there is no same RE occupied by any two time-frequency resources of the multiple time-frequency resources.

In one embodiment, the multiple time-frequency resources consist of no more than 192 time-frequency resources.

In one embodiment, the multiple time-frequency resources consist of no more than 1024 time-frequency resources.

For CSI reporting, the specific implementation of channel measurement and interference measurement is generally related to the type of CSI reported, and for CSI types such as RSRP (i.e., Reference Signal Received Power) and RSRQ (i.e., Reference Signal Received Quality), it is sufficient that the way of channel measurement complies with the definition of the CSI type.

As for CSI types such as SINR (i.e., Signal to Noise and Interference Ratio) and CQI, the person skilled in the art should know that the methods of channel measurement and interference measurement rely on the receiver's reception algorithm, which is determined by the receiver's equipment vendor; an exemplary, but non-limiting, implementation of CQI as an example is described as follows:

the first node measures RSs in the first RS resource to obtain an original channel matrix H_{r×t}, where r,t are the number of receiving antennas and the number of antenna ports for transmitting, respectively; under the condition of using a precoding matrix W_{t×l}, the encoded channel parameter matrix is H_{r×t}·W_{t×l}, where l is a rank or the number of layers: an equivalent channel capacity of H_{r×t}·W_{t×l} is calculated using, for example, SINR (i.e., Signal Interference Noise Ratio), EESM (i.e., Exponential Effective SINR Mapping), or RBIR (i.e., Received Block mean mutual Information Ratio) criterion. Further, the calculation of the equivalent channel capacity may also take into account the estimation of noise and interference as made by the first node, where the interference estimation relies on the measurement of the time-frequency resources used for the interference measurement. Typically, the measured interference may be colored, therefore, the first node may perform a whitening operation on the measured interference in conjunction with a receiver algorithm to calculate the equivalent channel capacity using the whitened interference.

The first node determines the CQI from the equivalent channel capacity by means of, for example, looking up a table.

In one embodiment, the at least one time-frequency resource is L time-frequency resource(s), the L being configured by downlink signaling, and the first node determines the L time-frequency resource on its own from the multiple time-frequency resources.

In one embodiment, the first node may employ different strategies for determining the at least one time-frequency resource to achieve different transmission effects: these strategies may be implementation related (i.e. not requiring standardization). Possible selection strategies include: the first node randomly selecting the at least one time-frequency resource from the multiple time-frequency resources, the first node selecting the at least one time-frequency resource from the multiple time-frequency resources on a rotating basis, the at least one time-frequency resource comprising the time-frequency resource that brings the least amount of interference out of the multiple time-frequency resources, and so on.

In addition to the above embodiments, with artificial intelligence (AI) or machine learning algorithms being introduced into the NR standard, the first node may also utilize AI or machine learning algorithms to determine the at least one time-frequency resource from the multiple time-frequency resources.

In one embodiment, the first CSI is transmitted on a Physical Uplink Shared Channel (PUSCH).

In one embodiment, the first CSI is transmitted on a Physical Uplink Control Channel (PUCCH).

In one embodiment, any 2 time-frequency resources among the multiple time-frequency resources are orthogonal in the time domain.

In one embodiment, the first CSI indicates channel information corresponding to a subband or, alternatively, the first CSI indicates channel information corresponding to a Bandwidth Part (BWP).

### Embodiment 2

Embodiment 2 illustrates a schematic diagram of a network architecture according to one embodiment of the present application, as shown in FIG. 2. FIG. 2 illustrates an architecture of 5G New Radio (NR), Long-Term Evolution (LTE) and Long-Term Evolution Advanced (LTE-A) systems. The 5G NR or LTE network architecture 200 may be called a 5G System/Evolved Packet System (5GS/EPS) or other suitable terminology; The EPS 200 may comprise one UE 201, an NG-RAN 202, a Evolved Packet Core/5G-Core Network (EPC-5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the EPC/5G-CN 210 via an SI/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. It should be noted that the 5G-CN in FIG. 2 attached may also be replaced by future modules, e.g., 6G core network modules. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application, and the gNB 203 corresponds to the second node in the present application.

In one embodiment, the gNB 203 supports Integrated Sensing and Communication (ISAC).

In one embodiment, the UE 201 supports generating CSI using Artificial Intelligence (AI) or Machine Learning, and the gNB 203 supports decompression of CSI using AI or deep learning.

In one embodiment, the UE 201 supports generating a trained model using training data or generating some of the parameters in a trained model using trained data, or, the UE 201 supports determining at least some of the parameters of Conventional Neural Networks (CNN) used for CSI reconstruction by training.

In one embodiment, the gNB 203 is a MarcoCellular base station, a Micro Cell base station, a PicoCell base station, a Femtocell Base Station, or a satellite device.

In one embodiment, the gNB 203 is a base station supporting large time-delay difference.

In one embodiment, the gNB 203 is a flight platform.

In one embodiment, the first node and the second node in the present application are respectively the UE 201 and the gNB 203.

### Embodiment 3

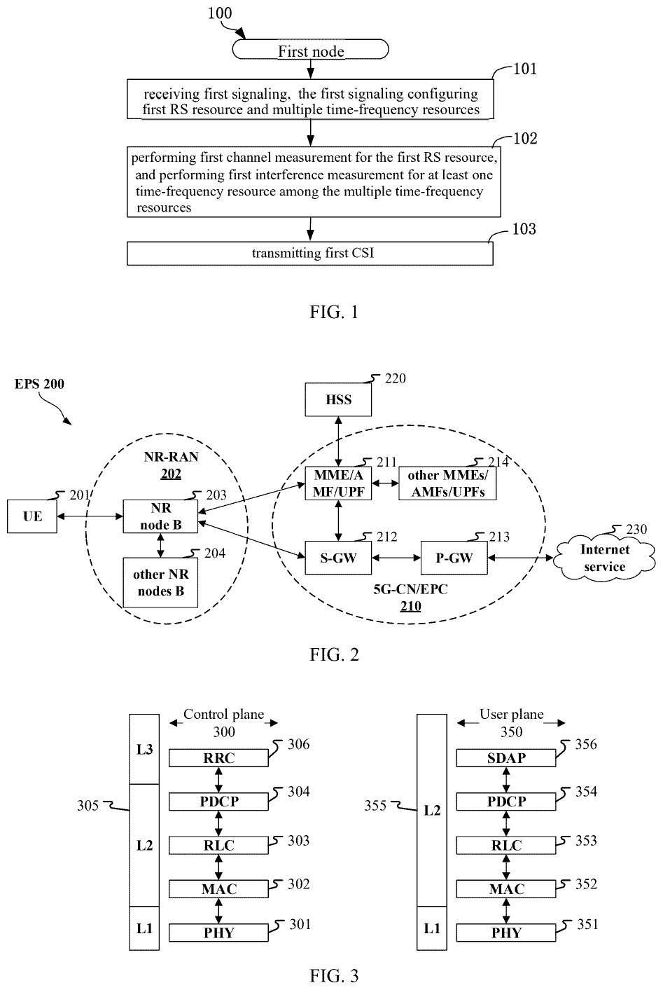

Embodiment 3 illustrates a schematic diagram of an embodiment of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, or RSU in V2X, vehicle-mounted equipment or vehicle-mounted communication module) and a second node (gNB, UEUE, or RSU in V2X, vehicle-mounted equipment or vehicle-mounted communication module), or between two UEs is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides data encryption and integrity protection, and the PDCP sublayer 304 also provides support for inter-cell mobility of the second node between first nodes. The RLC sublayer 303 provides packet segmentation and reassembly, retransmission of a lost packet via ARQ, and it also provides duplicate packet detection and protocol error detection. The MAC sublayer 302 provides mapping between the logical and transport channels and multiplexing of logical channels. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several upper layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the reference signal in the present application is generated by the PHY 301.

In one embodiment, the first CSI in the present application is generated by the PHY 301.

In one embodiment, the first signaling in the present application is generated by the MAC sublayer 302.

In one embodiment, the first CQI in the present application is generated by the PHY 301.

In one embodiment, the first signaling in the present application is generated by the RRC sublayer 306.

In one embodiment, the second signaling in the present application is generated by the RRC sublayer 306.

In one embodiment, the second signaling in the present application is generated by the MAC sublayer 302, or by the PHY 301.

### Embodiment 4

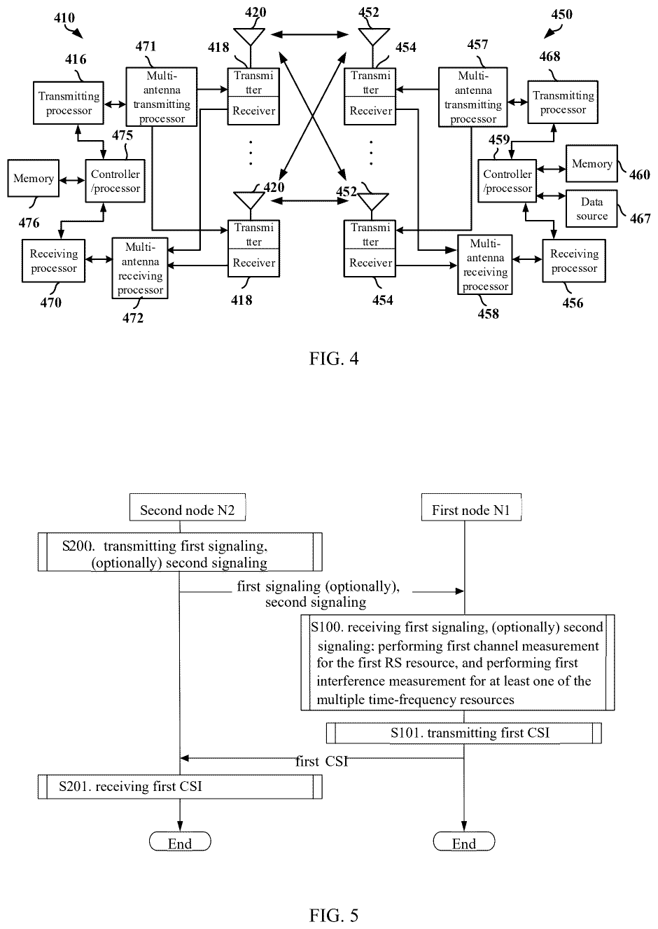

Embodiment 4 illustrates a schematic diagram of hardcore modules in a communication node according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs channel coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 de-interleaves and channel decodes the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data: the memory 460 may be called a computer readable medium. In the transmission from the second communication device 410 to the second communication device (node) 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs channel coding, interleaving and modulation and mapping, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data: the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes: the at least one memory and the computer program codes are configured to be used in collaboration with the at least one processor. The first communication device 450 at least receives a first signaling, the first signaling configuring a first RS resource and multiple time-frequency resources; and performs a first channel measurement for the first RS resource, and performs a first interference measurement for at least one time-frequency resource among the multiple time-frequency resources; and transmits a first CSI; herein, calculation of the first CSI is dependent on the first channel measurement and the first interference measurement: the at least one time-frequency resource is determined by the first communication device 450 itself.

In one embodiment, the first communication device 450 comprises a memory that stores a computer readable instruction program. The computer readable instruction program generates actions when executed by at least one processor. The actions include: receiving a first signaling, the first signaling configuring a first RS resource and multiple time-frequency resources; and performing a first channel measurement for the first RS resource, and performing a first interference measurement for at least one time-frequency resource among the multiple time-frequency resources; and transmitting a first CSI; herein, calculation of the first CSI is dependent on the first channel measurement and the first interference measurement; the at least one time-frequency resource is determined by the first communication device 450 itself.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling, the first signaling configuring a first RS resource and multiple time-frequency resources; and receives a first CSI; herein, calculation of the first CSI is dependent on a first channel measurement and a first interference measurement; the at least one time-frequency resource is unknown to the second node; the first channel measurement is performed based on the first RS resource, and the first interference measurement is performed based on at least one time-frequency resource among the multiple time-frequency resources.

In one embodiment, the second communication device 410 comprises a memory that stores a computer readable instruction program. The computer readable instruction program generates actions when executed by at least one processor. The actions include: transmitting a first signaling, the first signaling configuring a first RS resource and multiple time-frequency resources; and receiving a first CSI; herein, calculation of the first CSI is dependent on a first channel measurement and a first interference measurement: the at least one time-frequency resource is unknown to the second node: the first channel measurement is performed based on the first RS resource, and the first interference measurement is performed based on at least one time-frequency resource among the multiple time-frequency resources.

In one embodiment, the first communication device 450 corresponds to a first node in the present application, and the second communication device 410 corresponds to a second node in the present application.

In one embodiment, the first communication device 450 is a UE, and the second communication device 410 is a base station.

In one embodiment, the antenna 452, the receiver 454, the multi-antenna receiving processor 458 and the receiving processor 456 are used for channel measurement and interference measurement.

In one embodiment, the controller/processor 459 is used for channel measurement and interference measurement.

In one embodiment, the controller/processor 459 is used for generating the first CSI.

In one embodiment, the antenna 452, the transmitter 454, the multi-antenna transmitting processor 457, the transmitting processor 468, and the controller/processor 459 are used for transmitting the first CSI.

In one embodiment, the antenna 420, the transmitter 418, the multi-antenna transmitting processor 471 and the transmitting processor 416 are used for transmitting a reference signal on the first RS resource.

In one embodiment, the controller/processor 475 is used for transmitting a reference signal on the first RS resource.

In one embodiment, the antenna 420, the transmitter 418, the multi-antenna transmitting processor 471 and the transmitting processor 416 are used for transmitting a sensing signal on the multiple time-frequency resources.

In one embodiment, the controller/processor 475 is used for transmitting a sensing signal on the multiple time-frequency resources.

In one embodiment, the antenna 420, the receiver 418, the multi-antenna receiving processor 472, the receiving processor 470, and the controller/processor 475 are used for receiving the first CSI.

### Embodiment 5

Embodiment 5 illustrates a flowchart of transmission between a first node and a second node according to one embodiment of the present application, as shown in FIG. 5. In FIG. 5, a second signaling is optional.

The first node N1 receives a first signaling in step S100, the first signaling configuring a first RS resource and multiple time-frequency resources; and performs a first channel measurement for the first RS resource, and performs a first interference measurement for at least one time-frequency resource among the multiple time-frequency resources; and transmits a first CSI in step S101: where the at least one time-frequency resource is determined by the first node itself:
the second node N2 transmits the first signaling in step S200, and receives the first CSI in step S201; where the at least one time-frequency resource is unknown to the second node N2.

In Embodiment 5, calculation of the first CSI is dependent on the first channel measurement and the first interference measurement.

In one embodiment, an interference corresponding to each time-frequency resource among the multiple time-frequency resources and other than the at least one time-frequency resource does not exceed an interference corresponding to any time-frequency resource of the at least one time-frequency resource.

The above embodiment is equivalent to the reported CSI reflecting the worst channel status, which ensures transmission reliability and provides maximum scheduling flexibility for the second node.

In one subembodiment, the second node N2 transmits a radio signal to the first node N1 on a first physical layer channel, with scheduling information (e.g., MCS, time-frequency resources occupied, the number of occupied layers of MIMO, etc.) for the first physical layer channel relying on the first CSI; as long as interference superimposed on the first physical layer channel does not exceed the interference level caused by any L time-frequency resources of the multiple time-frequency resources, the reception quality of the first physical layer channel will be guaranteed.

In one embodiment, L is 1.

In one embodiment, L is configured by the first signaling.

In one embodiment, L is configured by a communication and sensing dynamic signaling (CSDS).

In one embodiment, the first signaling configures a second RS resource to be used for an interference measurement, the second RS resource being different from any one of the multiple time-frequency resources, the first interference measurement including a measurement of the second RS resource.

In the above embodiment, the calculation of the first CSI relies on an interference measured on the second RS resource and an interference measured on the at least one time-frequency resource. The interference on the second RS resource and the interference on the at least one time-frequency resource may represent different sources of interference, which in turn provides higher scheduling flexibility for the network device; e.g., the interference on the second RS resource may come from inter-user interference between multiple users, and the interference on the at least one time-frequency resource may come from sensing signals. It is to be noted that a person of ordinary skill in the art knows that how to utilize the interference to send radio signals may be determined by the network device itself and is not limited to the above-mentioned uses.

In one embodiment, the calculation of the first CSI relies on a sum of the interference measured on the second RS resource and the interference measured on the at least one time-frequency resource.

In one embodiment, the calculation of the first CSI relies on a sum of the interference measured on the second RS resource and a superimposed interference, the superimposed interference relying on the interference measured on the at least one time-frequency resource.

In one embodiment, the superimposed interference is the interference measured on the at least one time-frequency resource multiplied by a coefficient, the coefficient being a positive integer not less than 0 and not greater than 1.

In one embodiment, the coefficient is indicated explicitly by the second node via signaling or implicitly by the second node via signaling (i.e., derived by inference from other parameters indicated by the signaling).

In the above embodiment, the second node or the network device can be adjusted according to parameters such as the use of the at least one time-frequency resource or the number of occupied REs, to realize more flexible resource scheduling.

In one embodiment, the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

In one embodiment, the at least one time-frequency resource means L time-frequency resource(s), and the first CSI includes a first SINR; assuming that any L time-frequency resource(s) among the multiple time-frequency resources is(are) applied in an interference measurement, an obtained SINR is not lower than the first SINR.

In one embodiment, the at least one time-frequency resource means L time-frequency resource(s), and the first CSI includes a first interference power value; assuming that any L time-frequency resource(s) among the multiple time-frequency resources is(are) applied in an interference measurement, an obtained interference power value is not greater than the first interference power value.

In one embodiment, an interference corresponding to each time-frequency resource among the multiple time-frequency resources and other than the at least one time-frequency resource does not exceed an interference corresponding to any time-frequency resource of the at least one time-frequency resource.

In one embodiment, each time-frequency resource of the at least one time-frequency resource occupies Q subcarrier(s) in one multicarrier symbol: location(s) of the Q subcarrier(s) is(are) dependent on a first sensing waveform.

The above dependence of the location of the Q subcarriers on the first sensing waveform does not mean that the Q subcarriers must be determined in real time based on the first sensing waveform, but may also be determined by a predefined method, where the predefined process takes into account the characteristics of the first sensing waveform. Here are some possible implementations.

In one embodiment, a pattern made up by the Q subcarriers is predefined.

In one embodiment, the Q subcarriers are defined by means of a table, the formulation of the table being dependent on the frequency-domain characteristics of the first sensing waveform.

In one embodiment, the Q subcarriers are defined by means of a formula, the formula being obtained depending on the frequency-domain characteristics of the first sensing waveform.

In one embodiment, the Q subcarriers are the Q most energetic subcarriers in one multicarrier symbol corresponding to the first sensing waveform. Typical generation methods comprise performing a Fast Fourier Transform of the time-domain signal of the first sensing waveform, where the subcarriers corresponding to the Q most energetic frequency-domain signals among the obtained frequency-domain signals are the Q subcarriers.

In one embodiment, the Q subcarriers are composed of Q1 RBs in the one multicarrier symbol, and the Q1 RBs are the Q1 most energetic RBs in the one multicarrier symbol corresponding to the first sensing waveform.

In one embodiment, the first signaling indicates the Q.

In one embodiment, the first node N1 receives a second signaling in step S100, the second signaling indicating a frequency of the first sensing waveform: the second node N2 transmits the second signaling in step S200; where the first sensing waveform is a frequency modulated wave, and the location(s) of the Q subcarrier(s) is(are) dependent on the frequency of the first sensing waveform.

In one embodiment, the first sensing waveform is FMCW, the frequency of the first sensing waveform being the Chirp of the FMCW, i.e. the β of e^{jπ(βt+ω)t/τ}, where t means time and τ is the duration of a single transmission of the chirp.

In one embodiment, the first sensing waveform is FMCW, and a frequency of the first sensing waveform the Chirp of the FMCW, i.e. the β and ω of e^{jπ(βt+ω)t/τ}, where t means time and τ is the duration of a single transmission of the chirp.

In one embodiment, the first sensing waveform is a single frequency continuous waveform cos (2πft) and the frequency of the first sensing waveform is f.

In one embodiment, the second signaling is an RRC signaling.

In one embodiment, the second signaling is a piece of Downlink Control Information (DCI).

In one embodiment, the first signaling and the second signaling are respectively an RRC signaling and a DCI.

In one subembodiment, the second signaling is non-unicast (e.g., broadcast, groupcast, or multicast).

In one subembodiment, the second signaling is used for Downlink Grant DCI.

In one embodiment, the first sensing waveform is a single frequency continuous waveform.

In one embodiment, the first sensing waveform is FMCW.

### Embodiment 6

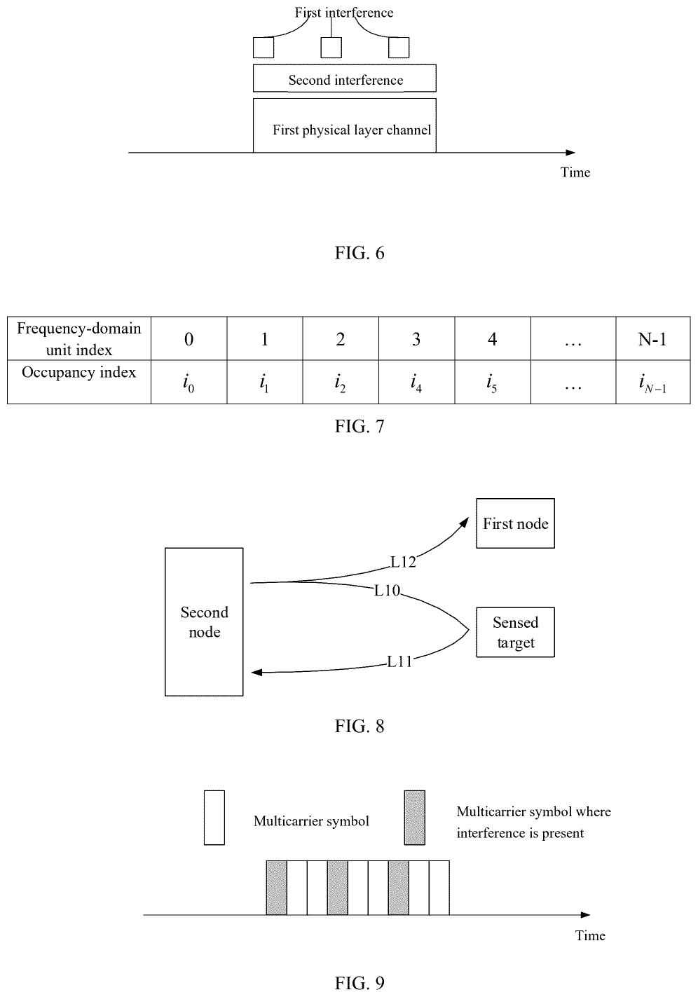

Embodiment 6 illustrates a schematic diagram of a first interference and a second interference according to one embodiment of the present application, as shown in FIG. 6.

In Embodiment 6, the second node transmits a radio signal to the first node on a first physical layer channel, where the scheduling information (e.g., MCS, time-frequency resources occupied, or the number of occupied layers of MIMO, etc.) of the first physical layer channel relies on the first CSI (the specific scheduling algorithms are determined by the network device or scheduler itself, e.g., common proportional fairness, the gluttony criterion, etc.).

As shown in FIG. 6, in the process of calculating the first CSI, the first node assumes that the interference experienced on the first physical layer channel comprises a first interference and a second interference: the first node obtains the second interference based on measurements of a second RS resource, and the first interference based on measurements of at least one of the multiple time-frequency resources; and a total power of the first interference and the second interference is used to calculate the first CSI.

In one embodiment, the first node assumes that the first interference overlaps with the first physical layer channel only on some of time resources, i.e., the multicarrier symbols in which the interference exists as given in in FIG. 6, and that the second interference overlaps with the first physical layer channel on all of the time resources, and thus the first interference is an interference power value obtained from measurements made for at least one of the multiple time-frequency resources multiplied by a coefficient, the coefficient being configurable or predefined to reflect the duty cycle of the multicarrier symbols where interference is present.

For the second node, the reception quality of the first physical layer channel can be guaranteed as long as the interference from radio signals superimposed on the first physical layer channel does not exceed the total power of the first interference and the second interference. The radio signals corresponding to the second interference may be radio signals for other inter-user physical layer channels other than the first node, or for other layers of MIMO; the radio signals corresponding to the first interference may be signals for some specific purposes, such as sensing waveforms, inter-base station reference signals, inter-base station backhaul signals, and so on. For different multicarrier symbols where interference exists, the second node may use different transmission beams to improve transmission efficiency:

In one embodiment, the first physical layer channel is a Physical Downlink Shared Channel (PDSCH).

In one embodiment, the first physical layer channel is a Physical Downlink Control Channel (PDCCH).

In one embodiment, the transmission channel mapped by the first physical layer channel is a Downlink Shared Channel (DL-SCH).

### Embodiment 7

Embodiment 7 illustrates a schematic diagram of a sorting order of frequency-domain units according to one embodiment of the present application, as shown in FIG. 7. In FIG. 7, frequency-domain unit indexes 0, 1, . . . , N−1 identify N frequency-domain units sequentially arranged from low to high on the frequency domain, and corresponding occupancy indexes for the N frequency-domain units are i₀, i₁ . . . and i_{N-1}, respectively, the occupancy indexes are non-negative integers and the occupancy indexes of any two frequency-domain units are different.

In Embodiment 7, frequency-domain unit(s) with the smaller (or larger) occupancy index are preferentially occupied by the at least one time-frequency resource of the present application, the occupancy index being determined in dependence on the power (or amplitude) of the first sensing waveform on a corresponding frequency-domain unit.

In one embodiment, the greater the power of the first sensing waveform on a frequency-domain unit, the smaller (or the larger) the corresponding occupancy index.

In one embodiment, the N frequency-domain units are respectively N consecutive subcarriers in a multicarrier symbol.

In one subembodiment, the multicarrier symbol is an OFDM symbol and the N is the size of the Fast Fourier Transform.

In one embodiment, the N frequency-domain units are respectively N consecutive Resource Blocks (RBs) in a multicarrier symbol.

In one embodiment, the Q subcarriers in the present application are all subcarriers in the frequency-domain units corresponding to the smallest (or largest) Q occupancy indexes among the N frequency-domain units.

In one subembodiment, under the condition that the Q is indicated, the Q subcarriers can be determined by looking up the table in FIG. 7.

In one embodiment, the Q subcarriers in the present application are all subcarriers excluding those used for reference signal in the frequency-domain units corresponding to the smallest (or largest) Q occupancy indexes among the N frequency-domain units.

In one embodiment, a frequency-domain location of the N frequency-domain units in the multicarrier symbol is indicated by the second signaling.

In one subembodiment, the second signaling indicates the frequency-domain location of a center frequency of the N frequency-domain units in the multicarrier symbol.

In one subembodiment, the second signaling indicates an index of a frequency-domain unit with the lowest frequency of the N frequency-domain units in the frequency-domain units included in the multicarrier symbol.

In one embodiment, the first sensing waveform is FMCW, and the center frequency of the N frequency-domain units is the Chirp of the FMCW, i.e. ω in e^{jπ(βt+ω)t/τ} where t means time and t is the duration of a single transmission of the chirp.

### Embodiment 8

Embodiment 8 illustrates a schematic diagram of signal transmission in Integrated Sensing and Communication (ISAC) according to one embodiment of the present application, as shown in FIG. 8.

In Embodiment 8, a second node transmits a first radio signal, the first radio signal comprising a sensing waveform for sensing and a modulation symbol for communication: the first radio signal arrives at a first node via link L12, the first node receives the modulation symbol for communication; the first radio signal arrives at a sensed target via link L10 and is reflected back to the second node via link L11, the second node senses parameter(s) such as moving speed and/or location of the sensed target based on a sensing waveform in the first radio signal.

In one embodiment, the sensing waveform for sensing and the modulation symbol for communication are both transmitted in time-frequency resources that are scheduled to a physical layer channel.

In one embodiment, the sensing waveform for sensing and the modulation symbol for communication occupy different subcarriers.

In one embodiment, there exists at least one OFDM symbol being occupied by both the sensing waveform for sensing and the modulation symbol for communication.

In one subembodiment, the sensing waveform for sensing and the modulation symbol for communication on the at least one OFDM symbol correspond to transmitting beams in different directions.

In one embodiment, the second node ensures that the sensing waveform for sensing does not introduce more interference to the modulation symbol for communication than is measured on the at least one time-frequency resource in this application.

The receiver of the sensing waveform in the attached FIG. 8 may also be deployed at other receiving devices than the second node, such as other base stations and the like.

### Embodiment 9

Embodiment 9 illustrates a schematic diagram of interference symbols according to one embodiment of the present application, as shown in FIG. 9. In FIG. 9, a square represents a multicarrier symbol, and gray-filled squares represent multicarrier symbols where interference is present.

In Embodiment 9, interference is present on only some of the multicarrier symbols, so that the interference power (that is, a linear value) measured for the at least one time-frequency resource is used to calculate the first CSI after multiplying it by a coefficient: the coefficient is not greater than 1.

The above coefficient may be indicated explicitly by the second node or, alternatively, implicitly by parameters such as resource scheduling.

In one embodiment, the second node periodically sends a sensing waveform (e.g. a Chirp waveform) on multicarrier symbols where interference is present, and does not send a sensing waveform on multicarrier symbols where interference is not present.

In one embodiment, for each multicarrier symbol where interference is present, interference is present for the full duration and the coefficient is ⅓.

In one embodiment, for each multicarrier symbol where interference is present, interference is present for only part of the duration, and the coefficient is less than ⅓ or equal to the duty cycle of the interference time.

It should be noted that the duty cycle of ⅓ in the accompanying FIG. 9 is only a non-limiting embodiment, and that during the sensing process, the second node may adjust the duty cycle on its own according to the desired sensing resolution.

### Embodiment 10

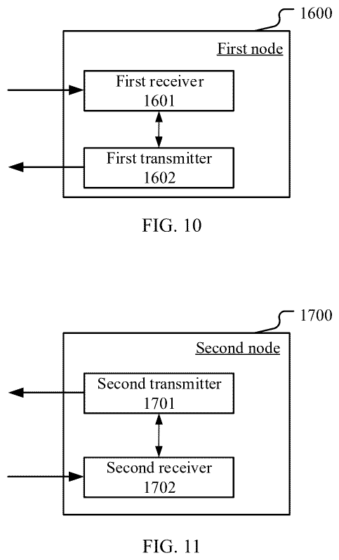

Embodiment 10 illustrates a structure block diagram of a processing device used in a first node according to one embodiment of the present application, as shown in FIG. 10. In FIG. 10, a processing device 1600 in a first node is comprised of a first receiver 1601 and a first transmitter 1602.

The first receiver 1601 receives a first signaling, the first signaling configuring a first RS resource and multiple time-frequency resources; and performing a first channel measurement for the first RS resource, and performing a first interference measurement for at least one time-frequency resource among the multiple time-frequency resources; and the first transmitter 1602 transmits a first CSI.

In Embodiment 10, calculation of the first CSI is dependent on the first channel measurement and the first interference measurement: the at least one time-frequency resource is determined by the first node itself.

In one embodiment, an interference corresponding to each time-frequency resource among the multiple time-frequency resources and other than the at least one time-frequency resource does not exceed an interference corresponding to any time-frequency resource of the at least one time-frequency resource.

In one embodiment, the first signaling configures a second RS resource to be used for an interference measurement, the second RS resource being different from any one of the multiple time-frequency resources, the first interference measurement including a measurement of the second RS resource.

In one embodiment, the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

In one embodiment, the at least one time-frequency resource means L time-frequency resource(s), and the first CSI includes a first SINR; assuming that any L time-frequency resource(s) among the multiple time-frequency resources is(are) applied in an interference measurement, an obtained SINR is not lower than the first SINR.

In one embodiment, the at least one time-frequency resource means L time-frequency resource(s), and the first CSI includes a first interference power value; assuming that any L time-frequency resource(s) among the multiple time-frequency resources is(are) applied in an interference measurement, an obtained interference power value is not greater than the first interference power value.

In one embodiment, each time-frequency resource of the at least one time-frequency resource occupies Q subcarrier(s) in one multicarrier symbol: location(s) of the Q subcarrier(s) is(are) dependent on a first sensing waveform.

In one embodiment, the first receiver 1601 receives a second signaling, the second signaling indicating a frequency of the first sensing waveform: herein, the first sensing waveform is a frequency modulated wave, and the location(s) of the Q subcarrier(s) is(are) dependent on the frequency of the first sensing waveform.

In one embodiment, the first node 1600 is a UE.

In one embodiment, the first transmitter 1602 comprises at least one of the antenna 452, the transmitter/receiver 454, the multi-antenna transmitting processor 457, the transmitting processor 468, the controller/processor 459, the memory 460 or the data source 467 in FIG. 4 of the present application.

In one embodiment, the first transmitter 1602 comprises the antenna 452, the transmitter/receiver 454, the multi-antenna transmitting processor 457, the transmitting processor 468, the controller/processor 459, the memory 460 and the data source 467 in FIG. 4 of the present application.

In one embodiment, the first receiver 1601 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1601 comprises at least the first three of the antenna 452, the receiver 454, the multi-antenna receiving processor 458, the receiving processor 456, the controller/processor 459, the memory 460 and the data source 467 in FIG. 4 of the present application.

### Embodiment 11

Embodiment 11 illustrates a structure block diagram of a processing device used in a second node according to one embodiment of the present application, as shown in FIG. 11. In FIG. 11, a processing device 1700 in a second node is comprised of a second transmitter 1701 and a second receiver 1702.

The second transmitter 1701 transmits a first signaling, the first signaling configuring a first RS resource and multiple time-frequency resources; and the second receiver 1702 receives a first CSI.

In Embodiment 11, calculation of the first CSI is dependent on a first channel measurement and a first interference measurement: the at least one time-frequency resource is unknown to the second node: the first channel measurement is performed based on the first RS resource, and the first interference measurement is performed based on at least one time-frequency resource among the multiple time-frequency resources.

In one embodiment, the second transmitter 1701 transmits a second signaling, the second signaling indicating a frequency of the first sensing waveform: herein, the first sensing waveform is a frequency modulated wave, and the location(s) of the Q subcarrier(s) is(are) dependent on the frequency of the first sensing waveform.

In one embodiment, an interference corresponding to each time-frequency resource among the multiple time-frequency resources and other than the at least one time-frequency resource does not exceed an interference corresponding to any time-frequency resource of the at least one time-frequency resource.

In one embodiment, the first signaling configures a second RS resource to be used for an interference measurement, the second RS resource being different from any one of the multiple time-frequency resources, the first interference measurement including a measurement of the second RS resource.

In one embodiment, the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

In one embodiment, the at least one time-frequency resource means L time-frequency resource(s), and the first CSI includes a first SINR; assuming that any L time-frequency resource(s) among the multiple time-frequency resources is(are) applied in an interference measurement, an obtained SINR is not lower than the first SINR.

In one embodiment, the at least one time-frequency resource means L time-frequency resource(s), and the first CSI includes a first interference power value; assuming that any L time-frequency resource(s) among the multiple time-frequency resources is(are) applied in an interference measurement, an obtained interference power value is not greater than the first interference power value.

In one embodiment, each time-frequency resource of the at least one time-frequency resource occupies Q subcarrier(s) in one multicarrier symbol: location(s) of the Q subcarrier(s) is(are) dependent on a first sensing waveform.

In one embodiment, the second receiver 1702 receives a sensing waveform to realize the sensing of the target.

In one embodiment, the second node 1700 is a base station.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second transmitter 1701 comprises the antenna 420, the transmitter 418, the transmitting processor 416 and the controller/processor 475.

In one embodiment, the second transmitter 1701 comprises the antenna 420, the transmitter 418, the multi-antenna transmitting processor 471, the transmitting processor 416 and the controller/processor 475.

In one embodiment, the second receiver 1702 comprises the antenna 420, the receiver 418, the multi-antenna receiving processor 472, the receiving processor 470, and the controller/processor 475.

In one embodiment, the second receiver 1702 comprises the controller/processor 475.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

It will be appreciated by those skilled in the art that this application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling configuring a first RS resource and multiple time-frequency resources; and performing a first channel measurement for the first RS resource, and performing a first interference measurement for at least one time-frequency resource among the multiple time-frequency resources; and
a first transmitter, transmitting a first CSI;
wherein calculation of the first CSI is dependent on the first channel measurement and the first interference measurement; the at least one time-frequency resource is determined by the first node itself.

2. The first node according to claim 1, characterized in that an interference corresponding to each time-frequency resource among the multiple time-frequency resources and other than the at least one time-frequency resource does not exceed an interference corresponding to any time-frequency resource of the at least one time-frequency resource.

3. The first node according to claim 1, characterized in that the first signaling configures a second RS resource to be used for an interference measurement, the second RS resource being different from any one of the multiple time-frequency resources, the first interference measurement including a measurement of the second RS resource.

4. The first node according to claim 1, characterized in that the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

5. The first node according to claim 1, characterized in that the at least one time-frequency resource means L time-frequency resource(s), and the first CSI includes a first SINR; assuming that any L time-frequency resource(s) among the multiple time-frequency resources is(are) applied in an interference measurement, an obtained SINR is not lower than the first SINR.

6. The first node according to claim 1, characterized in that the at least one time-frequency resource means L time-frequency resource(s), and the first CSI includes a first interference power value; assuming that any L time-frequency resource(s) among the multiple time-frequency resources is(are) applied in an interference measurement, an obtained interference power value is not greater than the first interference power value.

7. The first node according to claim 1, characterized in that each time-frequency resource of the at least one time-frequency resource occupies Q subcarrier(s) in one multicarrier symbol: location(s) of the Q subcarrier(s) is(are) dependent on a first sensing waveform.

8. The first node according to claim 7, characterized in comprising:
the first receiver, receiving a second signaling, the second signaling indicating a frequency of the first sensing waveform;
wherein the first sensing waveform is a frequency modulated wave, and the location(s) of the Q subcarrier(s) is(are) dependent on the frequency of the first sensing waveform.

9. A second node for wireless communications, comprising:
a second transmitter, transmitting a first signaling, the first signaling configuring a first RS resource and multiple time-frequency resources; and
a second receiver, receiving a first CSI;
wherein calculation of the first CSI is dependent on a first channel measurement and a first interference measurement; the at least one time-frequency resource is unknown to the second node; the first channel measurement is performed based on the first RS resource, and the first interference measurement is performed based on at least one time-frequency resource among the multiple time-frequency resources.

10. The second node according to claim 9, characterized in that an interference corresponding to each time-frequency resource among the multiple time-frequency resources and other than the at least one time-frequency resource does not exceed an interference corresponding to any time-frequency resource of the at least one time-frequency resource.

11. The second node according to claim 9, characterized in that the first signaling configures a second RS resource to be used for an interference measurement, the second RS resource being different from any one of the multiple time-frequency resources, the first interference measurement including a measurement of the second RS resource.

12. The second node according to claim 9, characterized in that the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.

13. The second node according to claim 9, characterized in that the at least one time-frequency resource means L time-frequency resource(s), and the first CSI includes a first SINR; assuming that any L time-frequency resource(s) among the multiple time-frequency resources is(are) applied in an interference measurement, an obtained SINR is not lower than the first SINR.

14. The second node according to claim 9, characterized in that the at least one time-frequency resource means L time-frequency resource(s), and the first CSI includes a first interference power value; assuming that any L time-frequency resource(s) among the multiple time-frequency resources is(are) applied in an interference measurement, an obtained interference power value is not greater than the first interference power value.

15. The second node according to claim 9, characterized in that each time-frequency resource of the at least one time-frequency resource occupies Q subcarrier(s) in one multicarrier symbol: location(s) of the Q subcarrier(s) is(are) dependent on a first sensing waveform.

16. The second node according to claim 9, characterized in comprising:
the second transmitter, transmitting a second signaling, the second signaling indicating a frequency of the first sensing waveform;
wherein the first sensing waveform is a frequency modulated wave, and the location(s) of the Q subcarrier(s) is(are) dependent on the frequency of the first sensing waveform.

17. A method in a first node for wireless communications, comprising:
receiving a first signaling, the first signaling configuring a first RS resource and multiple time-frequency resources; and performing a first channel measurement for the first RS resource, and performing a first interference measurement for at least one time-frequency resource among the multiple time-frequency resources; and
transmitting a first CSI;
wherein calculation of the first CSI is dependent on the first channel measurement and the first interference measurement; the at least one time-frequency resource is determined by the first node itself.

18. The method in the first node according to claim 17, characterized in that an interference corresponding to each time-frequency resource among the multiple time-frequency resources and other than the at least one time-frequency resource does not exceed an interference corresponding to any time-frequency resource of the at least one time-frequency resource.

19. The method in the first node according to claim 17, characterized in that the first signaling configures a second RS resource to be used for an interference measurement, the second RS resource being different from any one of the multiple time-frequency resources, the first interference measurement including a measurement of the second RS resource.

20. The method in the first node according to claim 17, characterized in that the at least one time-frequency resource means L time-frequency resource(s), and the first CSI includes a first CQI; assuming that any L time-frequency resource(s) among the multiple time-frequency resources is(are) applied in an interference measurement, a spectral efficiency of an obtained CQI is not lower than a spectral efficiency of the first CQI.
